(19) United States
(12) Patent Application Publication
(10) Pub. No.: US 2026/0220669 A1
(43) Pub. Date: Jul. 30, 2026

(54) METHOD FOR GENERATING AND SERVING CONTEXT-AUGMENTED CONTENT

(71) Applicant: Yieldmo, Inc., Nashua, NH (US)

(72) Inventors: David Sebag, Nashua, NH (US); Sambit Patnaik, Nashua, NH (US); Craig Simmons, Nashua, NH (US); Alex Johnston, Nashua, NH (US); Eric Shiffman, Nashua, NH (US)

(21) Appl. No.: 19/465,753

(22) Filed: Jan. 30, 2026

Related U.S. Application Data
(60) Provisional application No. 63/751,706, filed on Jan. 30, 2025.

(51) Int. Cl. G06Q 30/0241; G06T 11/00

(52) U.S. Cl. CPC G06Q 30/0276; G06Q 30/0277; G06T 11/00

(57) ABSTRACT

One variation of the method includes: accessing an ad template, designated for presentation within a target webpage, including by a set of ad elements; accessing a set of style rules; accessing a set of style elements for the target webpage; generating a prompt to generate a set of ads by assembling the set of ad elements and the set of style elements and satisfying the set of style rules; receiving the set of ads; for each ad in the set of ads, calculating a style score representing adherence of the ad to the set of style rules; selecting a subset of ads from the set of ads in response to the subset of ads exhibiting style scores exceeding a threshold style; and, in response to selection of a first ad, in the subset of ads, queuing the first ad for insertion into a media player on the target webpage.

### CROSS-REFERENCE TO RELATED APPLICATIONS

This Application claims the benefit of U.S. Provisional Application No. 63/751,706, filed on 30 Jan. 2025, which is incorporated in its entirety by this reference.

This Application is related to U.S. patent application Ser. No. 18/376,812, filed on 4 Oct. 2023, which is incorporated in its entirety by this reference.

### TECHNICAL FIELD

This invention relates generally to the field of media generation and, more specifically, to a new and useful method for generating and serving context-augmented content.

### BRIEF DESCRIPTION OF THE FIGURES

FIG. 1 is a flowchart representation of a method; and

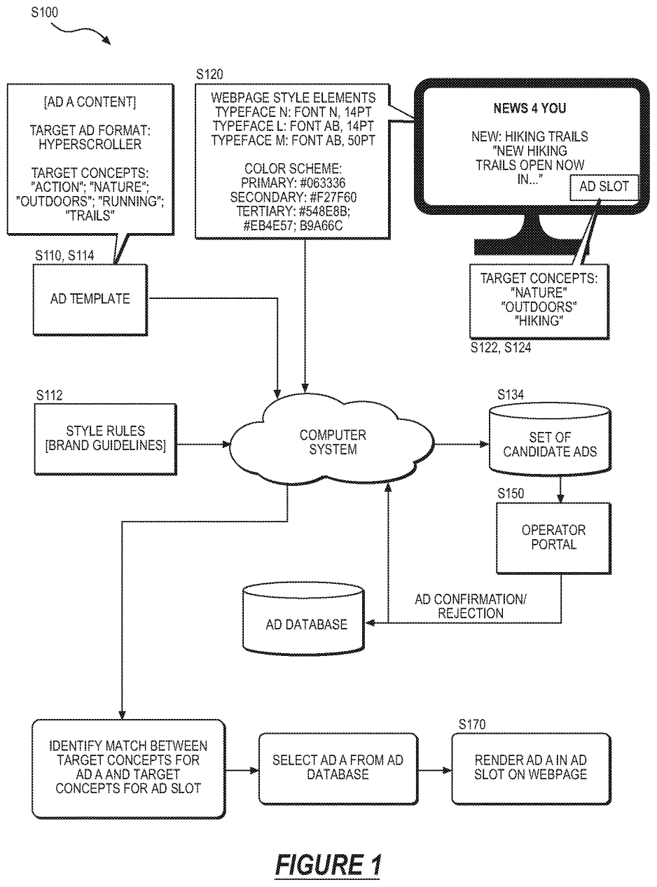

FIG. 2 is a schematic representation of one variation of the method;

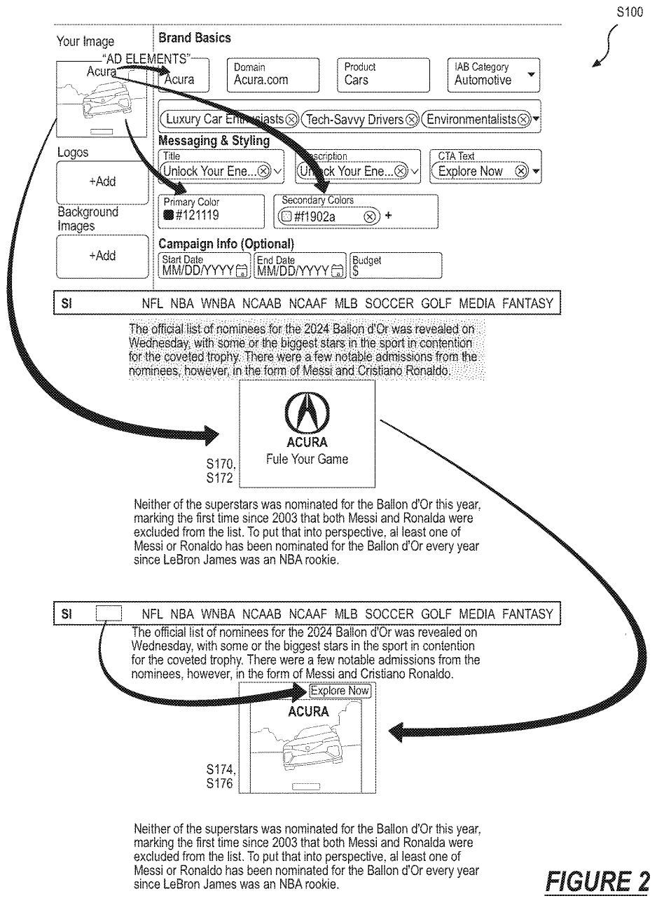

FIG. 3 is a flowchart representation of one variation of the method;

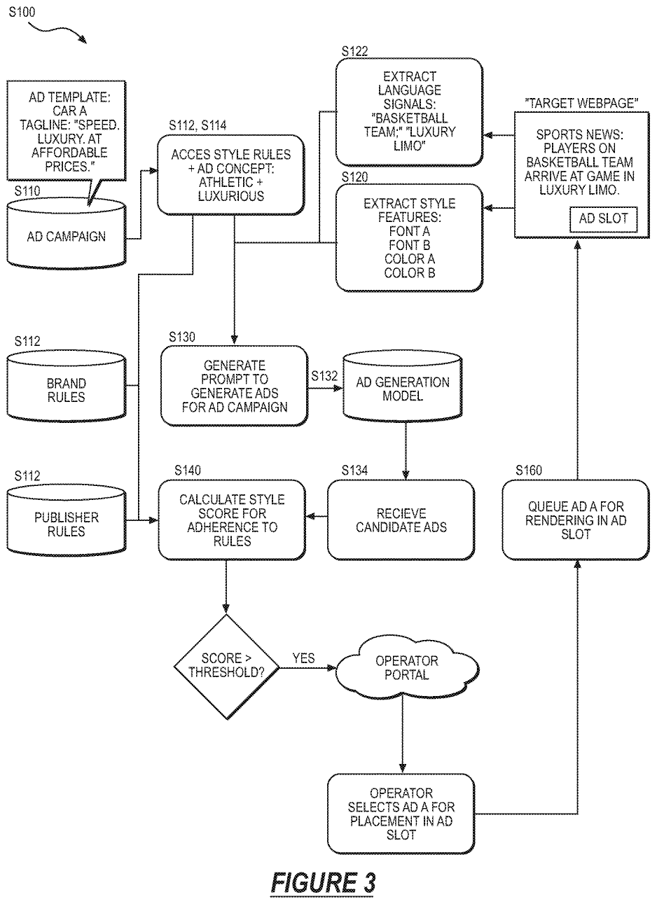

FIG. 4 is a flowchart representation of one variation of the method; and

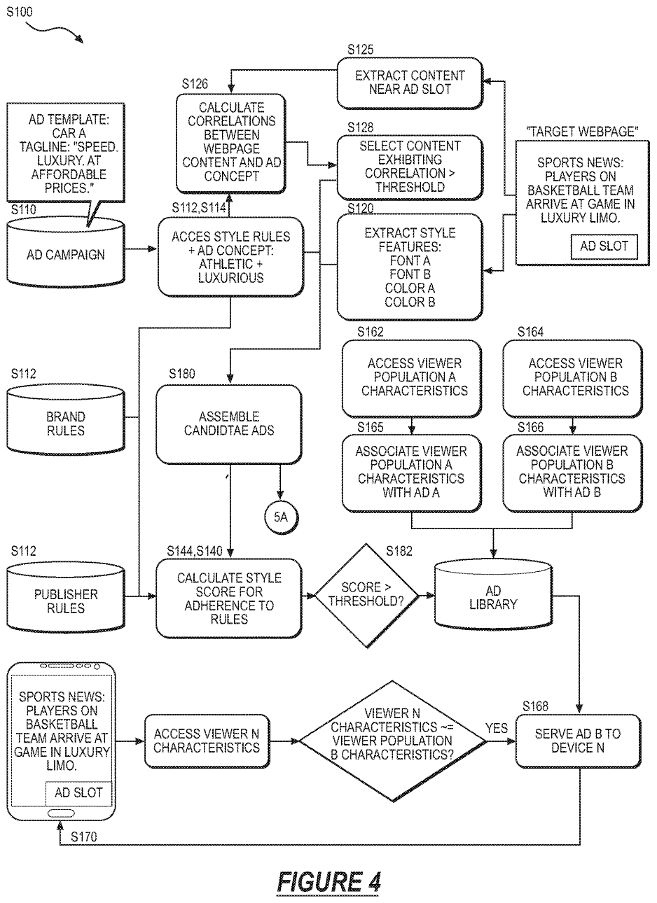

FIGS. 5A and 5B are flowchart representations of one variation of the method.

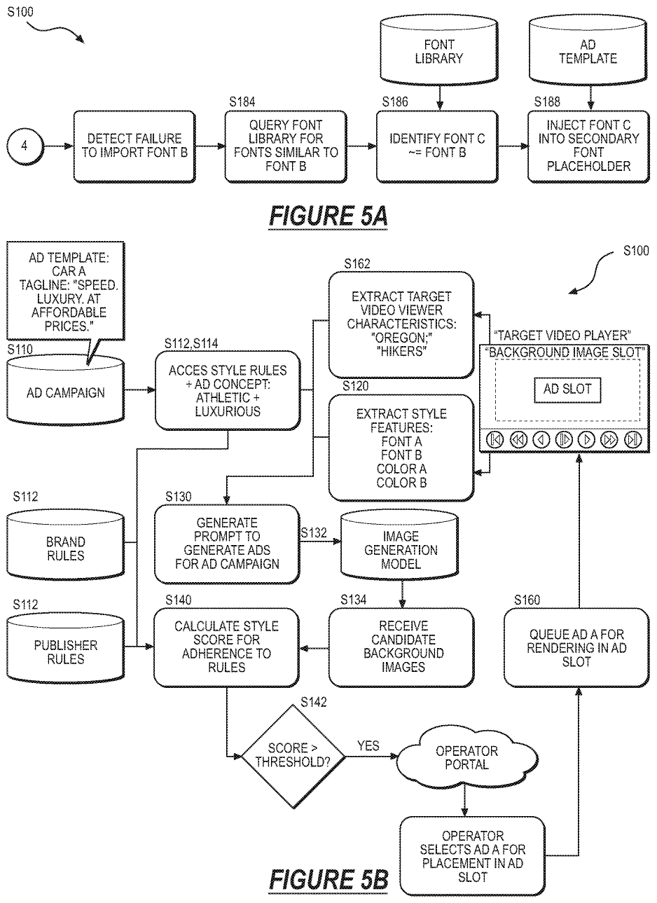

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

As shown in the FIGURES, a method S100 includes: accessing a set of ad elements designated for presentation within a target webpage in Block S110; accessing a set of style rules assigned to an ad campaign in Block S112; accessing a set of style elements for the target webpage, the set of style elements representing visual stylistic characteristics of the target webpage in Block S120; generating a prompt to generate a set of candidate ads based on the set of ad elements and the set of style elements for the target webpage and that satisfy the set of style rules for the ad campaign in Block S130; serving the prompt to an image generation model in Block S132; receiving the set of candidate ads from the image generation model in Block S134; for each candidate ad in the set of candidate ads, calculating a style score representing adherence of the candidate ad to the set of style rules for the ad campaign and/or proportional to visual congruence between the target webpage and the candidate ad in Block S140; selecting a subset of candidate ads from the set of candidate ads in response to the subset of candidate ads exhibiting style scores exceeding a threshold style score in Block S142; presenting the subset of candidate ads to an operator via an operator portal in Block S150; and, in response to selection of a first ad, in the subset of candidate ads, at the operator portal, queuing the first ad for presentation within instances of the target webpage in Block S160.

### 1.1 Variation: Style Scores+Automatic Ad Loading

One variation of the method S100 includes: generating a set of candidate ads based on, for each candidate ad in the set of candidate ads, accessing an ad template defining a set of template style slots, populating the set of template style slots with the set of style elements, and assembling the set of ad elements into the ad template to generate the candidate ad in Block S180; for each candidate ad in the set of candidate ads, extracting a set of features from the candidate ad in Block S144 and calculating a style score representing correspondence between the set of features and the set of style rules in Block S140; and selecting a first candidate ad for insertion into a media player on instances of the target webpage in response to a first style score, associated with the first candidate ad, exceeding a threshold style score in Block S182.

### 1.2 Variation: CTV+Background Images

Another variation of the method S100 includes: accessing a video ad associated with an ad campaign in Block S110; extracting a set of ad elements from the video ad in Block S114; accessing a set of style elements of a target video published on a video platform in Block S120; accessing a set of characteristics of a cohort of viewers associated with the target video in Block S162; generating a prompt to generate a background image, for presentation behind the video ad, based on the set of ad elements, the set of style elements of the target video, and the set of characteristics of the cohort of viewers in Block S130; serving the prompt to an image generation model in Block S132; receiving a set of candidate background images from the image generation model in Block S134; presenting the set of candidate background images to an operator via an operator portal in Block S150; and, in response to selection of a first background image in the set of candidate background images, queuing the first background image for presentation behind the video ad during playback of the target video (e.g., during an ad break) in Block S160.

### 1.3 Variation: Ad Assembly

One variation of the method S100 includes accessing an ad template including: a set of ad elements associated with an ad campaign; and a set of style rules associated with the ad campaign. The method S100 further includes: accessing a style sheet of a webpage; extracting a set of style elements from the style sheet of the webpage; based on the set of style rules and the set of style elements extracted from the style sheet of the webpage, assembling the set of ad elements into a set of candidates ads; presenting the set of candidates ads to an operator; and, in response to receiving selection of a first ad, in the set of candidate ads, queuing the first ad for insertion into an ad slot on instances of the webpage served to a population of viewers.

### 1.4 Variation: Real-time Web Ad Assembly

Another variation of the method S100 includes loading a visual element into an ad slot within a webpage accessed on a computing device, the video element including: a set of ad elements associated with an ad campaign; and a set of style rules associated with the ad campaign. This variation of the method S100 further includes, at the visual element: accessing a style sheet of the webpage; extracting a set of style elements from the style sheet of the webpage; assembling the set of ad elements into a responsive visual ad according to the set of style rules and the set of style elements extracted from the style sheet of the webpage; and rendering the responsive visual ad within the ad slot.

### 1.5 Variation: Contextual Ad Generation

One variation of the method S100 includes: accessing an ad description including an ad format and a target ad concept; accessing a style sheet of a webpage; extracting a set of style elements (e.g., typefaces, background colors) from the style sheet of the webpage; and detecting contextual elements (e.g., text, images) adjacent an ad slot on the webpage. This variation of the method further includes generating a prompt containing: a request to generate a visual ad in the ad format; the target ad concept; the set of style elements; and a representation of (e.g., copies of, a natural language description of) the contextual elements on the webpage.

This variation of the method further includes: serving the prompt to an image generation model; accessing the visual ad, assembled by the image generation model, responsive to the prompt; and loading the visual ad into the ad slot on the webpage server to a viewer.

In this variation, the method can further include: accessing a set of characteristics of the viewer; generating the prompt further containing a representation of the set of characteristics of the viewer; and serving the prompt to the image generation model to generate the visual ad that reflects the ad format, the target ad concept, contextual elements on the webpage, and characteristics of the viewer.

### 1.6 Variation: Context-augmented Video Ad

One variation of the method S100 includes: accessing a set of ad elements associated with an ad campaign; accessing a set of style elements of a target video published on a video platform; and accessing a set of characteristics of a cohort of viewers.

This variation of the method further includes generating a prompt containing: a request to generate a video ad; the set of ad elements; the set of style elements of the target video; and the set of characteristics of the cohort of viewers.

The method further includes: serving the prompt to an image generation model; accessing the video ad assembled by the image generation model responsive to the prompt; and serving the video ad to a video player, viewed by a viewer in the cohort of viewers, for rendering by the video player during an ad break during playback of the target video.

### 2. Applications

Generally, the method can be executed locally by a media player (e.g., a visual element, an ad slot, an iframe element) that contains: unrendered ad elements of a brand or product; and rules for rendering these ad elements to form a custom ad based on characteristics of a webpage (or native application or other document) on which the visual element is loaded. In particular, once loaded into an ad slot on a webpage, the media player can coordinate with a remote computer system (hereinafter a “computer system”) to execute Blocks of the method: to extract style elements of the webpage from a style sheet of the webpage, such as typefaces, background colors, and/or images from HyperText Markup Language (hereinafter “HTML”) and/or Cascading Style Sheets (hereinafter “CSS”) associated with the webpage; to fuse these style elements of the webpage with ad elements contained in the media player—according to predefined rules contained in the media player—to generate a custom visual ad that presents the brand or product in a style (e.g., a visual language) of the webpage; and to render this custom visual ad within the ad slot.

Accordingly, the computer system can implement a set of style elements—extracted from a target webpage—to assemble and render a custom visual ad in an ad slot on the target webpage such that the custom visual ad conforms to visual stylistic characteristics of surrounding publisher content. Therefore, by reducing visual discordance between content rendered in the ad slot and adjacent content rendered on the target webpage, the computer system can render the custom visual ad as a visually integrated portion of the target webpage while still presenting ad elements of an ad campaign.

The media player can thus generate—in real-time—a custom visual ad that complements content on the webpage and may appear to a viewer to be part of the webpage itself, thereby increasing viewer perception of a more seamless webpage, absent clutter or discordant visual content, such as visually striking or distracting advertisements.

In particular, the method S100 can be implemented by a publisher to: access a set of ad creatives (e.g., ad elements), generated by an advertiser; and assemble the set of ad creatives into complete advertisements that conform to a style of the target webpage—on which the complete advertisement will be injected—to create a seamless webpage absent discordant visual content, to thereby enable a viewer, viewing the complete advertisement on the webpage, to perceive the complete advertisement as visually integrated with surrounding webpage content and read, understand, and visually engage with the complete advertisement.

Furthermore, the computer system can bound generation of ads, by an artificial intelligence model, by generating a bounded input including: a set of publisher rules, a set of ad elements assigned to an ad campaign, and a limited set of webpage characteristics (e.g., typeface, color, iconography, content, text, storyline) extracted from the target webpage. Therefore, by constraining a feature space to the set of publisher rules, the set of ad elements, and the set of webpage characteristics, the computer system can reduce a feature space available to the artificial intelligence model and thereby reduce computational resources utilized by the artificial intelligence model for generation of the candidate ads and increase a likelihood that returned candidate ads satisfy the set of publisher rules and the set of style rules assigned to the ad campaign.

### 2.1 Preemptive Ad Generation

In one variation, a computer system implements similar methods and techniques to preemptively generate a custom visual ad that presents a particular brand or product and is designated for insertion onto a particular website, onto a particular webpage, or into a particular ad slot in a particular webpage.

For example, the computer system can implement similar methods and techniques: to retrieve style elements of a particular webpage; to retrieve contextual elements (e.g., text, images, colors) around a designated ad slot on the webpage; combine the style elements and contextual elements with ad elements from an ad campaign to generate a custom visual ad specific to this ad slot and this ad campaign; and serve this custom visual ad to the ad slot on the webpage specifically during the ad campaign. In this example, the computer system can also: retrieve characteristics (e.g., demographics) of different cohorts of viewers who have or may visit the webpage; generate a custom visual ad for each cohort of viewers based on each cohort's characteristics and the style elements of the webpage, contextual elements extracted from the webpage, and ad elements from the ad campaign; and selectively serve these custom visual ads to the ad slot on instances of the webpage based on characteristics of viewers accessing these instances of the webpage during the ad campaign.

In this variation, the computer system can: assemble cohort characteristics, style elements of the webpage, contextual elements extracted from the webpage, ad elements, and/or a callout for a particular ad format into a prompt; and serve this prompt to an AI image generator that assembles and returns a custom visual ad. Alternatively, the AI image generator can return multiple candidate ads. The computer system can then present these candidate ads to an operator (e.g., a brand representative) for filtering and selection of a final ad to serve to the target website, webpage, and/or ad slot.

Thus, in this variation, the computer system can generate a custom visual ad that reflects both style and content (e.g., text, images) presented on the target website or webpage such that a story presented in the custom visual ad integrates with a context (e.g., a story, a larger message, a theme) of the target website or webpage, thereby increasing viewer perception of a more seamless webpage with a more cohesive (or less discordant) message.

### 2.2 CTV+Background Images

In another variation, the computer system implements these methods and techniques to preemptively generate background images intended for injection behind video ads to increase contextual relevance of these video ads.

For example, the computer system can implement similar methods and techniques: to access a video ad associated with an ad campaign and extract ad elements from the video ad; to retrieve style elements of a particular video stream and retrieve contextual elements associated with the particular video stream; to combine the style elements and contextual elements with the ad elements to generate a background image specific to the video ad; and to serve the background image for insertion behind the video ad during playback of the target video stream, and specifically during the ad campaign.

In this example, the computer system can also: retrieve characteristics of different cohorts of viewers who have or may access an instance of the target video stream; generate a background image for each cohort of viewers based on each cohort's characteristics and the style elements and contextual elements of the target video stream and the ad elements extracted from the video ad; and selectively serve these cohort-specific background images for insertion behind the video ad during instances of playback of the target video stream based on characteristics of viewers accessing these instances of playback during the ad campaign.

In this variation, the computer system can assemble cohort characteristics, style elements of the video stream, contextual elements associated with the video stream, and ad elements into a prompt; and serve this prompt to an artificial intelligence image generator that assembles and returns a background image. Alternatively, the artificial intelligence image generator can return multiple candidate background images, and the computer system can present these candidate background images to an operator for selection of a background image to serve for insertion behind the video ad during the ad break.

Thus, in this variation, the computer system can generate a background image that reflects style elements and contextual elements of the target video stream such that the video ad, when rendered with the background image during the ad break, conforms to a visual language of the target video stream and reduces visual discordance at the ad break.

### 2.3 Video Ad Generation

In a similar variation, the computer system implements these methods and techniques to preemptively generate a custom video ad designated for insertion onto a particular website (e.g., a video streaming site) or into a particular ad slot, defined by an ad break (e.g., placement opportunity), in the particular website, such as during an ad break during playback of a video stream.

For example, the computer system can implement similar methods and techniques: to retrieve style elements of a particular video stream; to retrieve contextual elements (e.g., text, images, colors) of this particular video stream; to combine the style elements and contextual elements with ad elements from an ad campaign to generate a custom video ad specific to this ad break and this ad campaign; and to serve this custom video ad to the ad break on the webpage during playback of the video stream, and specifically during the ad campaign. In this example, the computer system can also: retrieve characteristics (e.g., demographics) of different cohorts of viewers who have or may access an instance of this particular video stream; generate a custom video ad for each cohort of viewers based on each cohort's characteristics and the style elements of the video stream, contextual elements extracted from the video stream, and ad elements from the ad campaign; and selectively serve these custom video ads to the ad break during instances of playback of the video stream based on characteristics of viewers accessing these instances of playback of the video stream during the ad campaign.

In this variation, the computer system can alternatively: assemble cohort characteristics, style elements of the video stream, contextual elements extracted from the video stream, and ad elements into a prompt; and serve this prompt to an AI image generator that assembles and returns a sequence of images representing a custom video ad.

Thus, in this variation, the computer system can generate a custom video ad that reflects both style and content (e.g., text, images) presented within a target video stream or video streaming website such that the custom video ad flows seamlessly from content in the video stream, and a story presented in the custom video ad integrates with a theme of the target video stream or streaming site, thereby increasing viewer perception of a more seamless video stream with a more cohesive (or less discordant) message and/or increasing viewer engagement with the video ad.

The method S100 is described herein as executed by a remote computer system (e.g., a remote server, hereinafter a “computer system”). However, Blocks of the method S100 can be executed by one or more entities accessing the network, by a local computer system, or by any other computer system—hereinafter a “system.”

### 3. Local Style Matching

Generally, the method includes, at a visual element loaded onto a webpage: accessing an ad template; accessing a target webpage for presentation of a target ad derived (or generated) from the ad template, the target webpage defining an ad slot; extracting local style elements from the webpage, such as proximal the ad slot; incorporating these local style elements into style placeholders (e.g., variables, tokens, fields, markers, slots) in the ad template; and generating an ad, representing local style elements, based on the ad template and local style elements from the webpage.

### 3.1 Ad Templates+Ad Elements

In one implementation, the method includes accessing an ad template (or “asset”), such as an ad container, for a particular interactive digital ad, the ad template defining a set of style placeholders configured to receive style data. In particular, the ad template can include: ad elements for a particular ad campaign, such as videos, animated images, text, icons, and/or a sequences of images (or static frames); and style placeholders configured to receive style data (e.g., typeface data, color palette data, contextual elements data) from a target webpage (e.g., a webpage on which the ad will be rendered).

The ad template can also include: a header configured to receive style and/or text inputs and render over a body of the ad display; size specifications of a target ad (e.g., 300-pixel by 250-pixel, 728-pixel by 90-pixel, 350-pixel by 50-pixel); style guidelines (e.g., “approachable”, “luxury”, “action”) associated with the ad campaign; audience tags configured to dynamically update content of the ad based on viewership (e.g., cookie) data; and/or target user engagement characteristics.

In one implementation, the computer system can extract ad elements from an ad template and/or a pre-generated ad provided by an advertiser. For example, the computer system can: access an assembled ad generated for the ad campaign; and extract the set of ad elements from the assembled ad generated for the ad campaign. Then, the computer system can generate candidate ads based on these ad elements, as further described herein.

### 3.1.1 Ad Template Selection

In one implementation, a computer system executing Blocks of the method S100 can select a particular ad template, in a corpus of ad templates associated with an ad campaign, based on content represented on a target webpage.

For example, the computer system can: access a corpus of ad templates associated with the ad campaign; access an ad profile, in a set of ad profiles, for each ad template in the corpus of ad templates, the ad profile representing characteristics of the ad template. Then, for the target webpage, the computer system can: access a set of webpage characteristics (e.g., content represented on the target webpage, characteristics of viewers of the target webpage); calculate a correlation between each ad profile, in the set of ad profiles, and the set of webpage characteristics; and, in response to a first correlation, for a first ad profile associated with the ad template, exceeding a threshold correlation, associate the ad template with the target webpage.

Therefore, the computer system can select an ad template for a target webpage based on correlation between characteristics of the ad template and characteristics of the target webpage, thereby increasing contextual relevance between a rendered ad and content of the target webpage and increasing viewer interaction with the rendered ad.

### 3.2 Typeface Matching

Generally, the visual element can: identify a set of typefaces on a webpage, such as a set of typefaces present on a webpage rendered on an endpoint device; and populate these typeface placeholders in the ad template with these typefaces.

In one implementation the visual element can: access a corpus of webpage content, such as via HTML or CSS; identify styling data based on language signals in the corpus of webpage content (e.g., “font-family”, “uppercase”, “.ttf”); extract a set of typefaces present on the webpage based on styling data in the corpus of webpage content; and populate a set of typeface placeholders in the ad template with the set of typefaces. In particular, the visual element can, in response to accessing the corpus of webpage content and identifying styling data: select a particular typeface in the styling data according to the style rules defined by the ad template; and populate a typeface placeholder in the ad template with this particular typeface.

In another implementation, for each typeface in the set of typefaces, the visual element can: identify a set of typeface metadata representing a size, a weight, and/or a format (e.g., bold, italic, underline); and assign (or identify) a hierarchy of typefaces in the set of typefaces based on the set of metadata for each typeface. In one example, the visual element can: identify a primary, or header, typeface for the webpage; identify a secondary, or body, typeface for the webpage; identify a logo typeface for the webpage, such as based on a font size exceeding a font size threshold (e.g., 72 pt); and/or identify an image caption typeface for the webpage, such as based on a font size falling below a second font size threshold (e.g., 8 pt). Based on these typeface categories, the visual element can sort typefaces in the set of typefaces into a typeface hierarchy.

The visual element can then select a subset of typefaces from the set of typefaces, based on the hierarchy of typefaces, for populating typeface placeholders within the ad template. For example, the visual element can define the subset of typefaces by: excluding all typefaces defining a size below a threshold size (e.g., 11 pt); excluding all typefaces defining a second size exceeding a second threshold size (e.g., 50 pt); and including typefaces within a local proximity to an ad slot selection for insertion of the ad. In particular, the visual element can: identify a large (e.g., the largest) typeface present on the webpage; identify the large typeface as a ‘logo’ associated with a particular brand of the webpage; and exclude the large typeface from the subset of typefaces.

In another example, the visual element can implement methods and techniques as described herein to identify a second set of typefaces characteristic of other ads, external to the particular ad campaign, and exclude the second set of typefaces from the subset of typefaces.

Similarly, the visual element and/or a computer system executing Blocks of the method S100 can: extract primary and secondary typefaces from the target webpage; and populate slots (e.g., placeholders) in the ad template with these primary and secondary typefaces. In particular, the visual element and/or the computer system can: access a style sheet associated with the target webpage; extract a primary typeface from the style sheet; and extract a secondary typeface from the style sheet. In this example, the computer system can assemble a set of candidate ads based on the primary typeface and the secondary typeface. For example, the computer system can assemble the set of candidate ads by populating a primary typeface slot in the ad template with the primary typeface and populating a secondary typeface slot in the ad template with the secondary typeface.

Additionally or alternatively, in this implementation, the computer system can select substitute typefaces, such as in response to detecting unavailability (e.g., trademarked, failure to import a typeface) of a particular typeface. In particular, the computer system can query a typeface library for a typeface visually similar to the particular typeface.

For example, in response to detecting failure to populate the secondary typeface slot in the ad template with the secondary typeface, the computer system can: query a typeface library for typefaces visually corresponding to the secondary typeface in Block S184; select a third typeface from a set of candidate typefaces returned by the typeface library in Block S186; and inject the third typeface, in replacement of the secondary typeface, into the secondary typeface slot in the ad template in Block S188.

Accordingly, the computer system and/or visual element can: extract typefaces present on a webpage; select a subset of these typefaces; and incorporate the subset of typefaces into the ad template.

Therefore, the visual element populates the ad template with relevant text-related style data, such as based on a proximity of these text-related style data to a particular ad slot on the webpage, to generate an ad that is seamlessly integrated into the webpage content, enabling the user to maintain an uninterrupted browsing session while engaging with the webpage.

### 3.3 Color Matching

Similarly, the visual element can: extract a set of colors (or “color palette”) from a webpage; and populate color placeholders (e.g., variables, tokens, fields, markers, slots) in the ad template with the set of colors.

In particular, the visual element can: access the corpus of webpage content, such as via HTML or CSS; identify styling data based on language signals in the corpus of webpage content (e.g., color, background-color, hex codes, RGB/rgba values, HSL/hsla values); extract a set of colors based on these styling data; and populate a set of color placeholders in the ad template with the set of colors.

In one example, the visual element can, in response to accessing the corpus of webpage content and identifying styling data: select a particular color in the styling data according to the style rules defined by the ad template; and populate a color placeholder in the ad template with this particular typeface.

In another example, for each color in the set of colors, the visual element can: identify a usage frequency of the color; and assign (or identify) a hierarchy of colors, including a subset of primary colors, a subset of secondary colors, and/or a subset of neutral colors, from the set of colors based on the usage frequency for each color.

The visual element can then select a set of candidate colors, such as one from each of the subset of primary colors, the subset of secondary colors, and/or the subset of neutral colors. Additionally or alternatively, the visual element can select the set of candidate colors by excluding the subset of neutral colors. Additionally or alternatively, the visual element selects a first primary color, and then selects a first secondary color based on a difference between the first primary color and the first secondary color exceeding a threshold difference.

In one implementation, the visual element can: assign a color, from the set of colors, to a text block within the ad template; and assign a second color, from the set of colors, to a background image of the ad template. For example, the visual element can identify colors present in the ad template; and select the set of colors further based on colors present in the ad template, such that the set of candidate colors complement colors present in the ad template. For example, the visual element can exclude “white” (and associated hex codes, RGB values, HSL values, etc.) as a typeface color in response to detecting “white” (and associated hex codes, RGB values, HSL values, etc.) as a background color for a particular text block in the ad template.

Similarly, the visual element and/or a computer system executing Blocks of the method S100 can: extract primary and secondary colors from the target webpage; and populate slots (e.g., placeholders) in the ad template with these primary and secondary colors. In particular, the visual element and/or the computer system can: access a style sheet associated with the target webpage; extract a primary color from the style sheet; and extract a secondary color from the style sheet. In this example, the computer system can assemble a set of candidate ads based on the primary typeface and the secondary typeface. For example, the computer system can assemble the set of candidate ads by populating a primary color slot in the ad template with the primary color and populating a secondary color slot in the ad template with the secondary color.

Additionally or alternatively, in this implementation, the computer system can select substitute colors, such as in response to detecting unavailability (e.g., trademarked, failure to import a color) of a particular color. In particular, the computer system can query a color library for a color visually similar to the particular color. For example, in response to detecting failure to populate the secondary color slot in the ad template with the secondary color, the computer system can: query a color library for colors visually corresponding to the secondary color; select a third color from a set of candidate colors returned by the color library; and inject the third color, in replacement of the secondary color, into the secondary color slot in the ad template.

Accordingly, the visual element can: identify colors present on a webpage; assemble these colors into a color palette (e.g., based on the hierarchy of colors); select a subset of these colors; and incorporate the subset of colors into the ad template.

Therefore, by populating an ad template with relevant color-related style data, the visual element can generate an ad exhibiting a similar (or the same) color scheme as a webpage, such that the ad can be seamlessly integrated into the webpage content, enabling the user to maintain an uninterrupted browsing session while engaging with the webpage.

### 3.4 Other Features

The visual element can extract additional relevant style data from the style sheet associated with the webpage. For example, the visual element can identify and extract style elements such as: kerning; text transformations; aspect ratios; interaction styles, such as transitions (e.g., from page-to-page), keyframe-based animations (e.g., scroll-responsive content), and/or cursor styles; and/or structural features, such as geometry (e.g., rounded borders), z-index (e.g., layering of elements, shadows), and/or overflow behavior.

### 3.5 Local Style Elements+Content

In one implementation, the computer system (and/or visual element) can generate a set of candidate ads based on local style elements, such as style elements proximal the intended ad slot for the target ad.

In particular, the computer system can: access a target ad concept associated with the ad campaign in Block S114; extract a set of contextual elements from the target webpage proximal a location of the media player on the target webpage in Block S125; derive a set of correlations between the set of contextual elements and the target ad concept in Block S126; in response to a subset of contextual elements exhibiting a correlation, in the set of correlations, exceeding a threshold correlation, select the subset of contextual elements in Block S128; and generate a prompt to generate the set of candidate ads based on the subset of contextual elements.

In a similar implementation, the computer system (and/or visual element) can generate a set of candidate ads based on content represented within the target webpage, such as content rendered proximal the target ad slot.

For example, the computer system can: extract a set of language signals from the target webpage in Block S122; derive a content type of the target webpage based on the set of language signals in Block S124; and assemble a set of candidate ads based on the content type of the target webpage.

In one variation, a media player embedded within the target webpage can execute Blocks of the method S100 to derive the set of style elements from the target webpage. For example, the media player can: access an instance of the target webpage at the media player embedded within the target webpage; and extract a set of style elements from the instance of the target webpage at the media player embedded within the target webpage. In particular, the computer system can access the set of style elements for the target webpage including, at a media player embedded within the target webpage and during a first time period prior to publication of the target webpage, accessing the target webpage and extracting the set of style elements from the target webpage at the media player embedded within the target webpage. Then, during a second time period succeeding publication of the target webpage, the computer system can load the first ad into the media player within a first instance of the webpage.

Therefore, the computer system (and/or the media player) can promote uniformity (e.g., cohesion) between the ad rendered in the ad slot and the webpage by injecting the ad with content proximal the target ad slot, while reducing latency of ad loading and/or webpage loading.

### 3.6 Variation: Computer Vision Feature Extraction

The method is described herein as executed by a visual element to extract style information from a corpus of webpage content, such as a style sheet, HTML, and/or CSS code. Additionally or alternatively, in one variation, a computer system (and/or the visual element) can implement computer vision techniques to extract stylistic information from a webpage, and incorporate relevant style elements into an ad template to generate a target ad.

In particular, the computer system and/or the visual element can: access an image of the target webpage; extract a set of features from the image of the target webpage; extract the set of style elements based on the set of features; and, for each candidate ad in the set of candidate ads, populate a corresponding style element slot with a style element from the set of style elements.

In this variation, the computer system can access a webpage and identify a set of objects, such as text, a set of colors, locations of faces, images, a set of characteristic and/or context tags, etc., through computer vision techniques, such as optical character recognition (or “OCR”), natural language processing, label detection techniques, face detection techniques, image attributes extraction techniques, etc. For example, the webpage can: define an article on a news website, the article describing an awards ceremony for a set of films; define a particular color palette, typical of the webpage; and define a particular set of typefaces. In the foregoing example, the computer system can extract contextual labels representing content described in the article (e.g., “films,” “award-winning,” “new movies”), and a histogram of colors represented in the image (e.g., frequency of 35% of Hex Color Code #808080—gray, 25% of Hex Color Code #000000—black, 20% of Hex Color Code #FF 0000—red, 10% Hex Color Code #C0C0C0—silver). In one variation, the computer system can implement OCR techniques to detect text and delineate text blocks by size, color, typeface, formatting, and/or location within the webpage. For example, the computer system can identify and label a text block (or a set of text blocks) within the article as a brand logo, an image caption, a header font, or other typeface category based on juxtaposition of these text blocks within the webpage (or article), text block size, text block color, etc.

Accordingly, the computer system can implement computer vision to extract style elements from a target webpage and populate the ad template with these features.

### 3.7 Ad Generation+Rendering

Generally, the visual element can implement methods and techniques as described herein to access an ad template and select a set of style elements, such as from a webpage, for incorporation into the ad template. In particular, the visual element can insert the set of style elements into relevant placeholders defined by the ad template; assemble an interactive digital ad exhibiting style elements in the set of style elements based on ad elements in the ad template and the set of style elements; and render this interactive digital ad in the visual element. More specifically, the computer system can: access an ad template defining a set of template style slots; populate the set of template style slots with the set of style elements; and assemble the set of ad elements into the ad template to generate a set of candidate ads.

For example, the visual element can: identify a first placeholder in the ad template for a primary (e.g., header) typeface; insert a first typeface into the first placeholder the primary typeface based on the subset of typefaces; identify a second placeholder in the ad template for a secondary (e.g., body) typeface; and insert a second typeface into the second placeholder, the secondary typeface based on the subset of typefaces. Similarly, the visual element can: identify a first placeholder in the ad template for a primary (e.g., background) color; insert a first color into the first placeholder representing the primary color based on the subset of primary colors; identify a second placeholder in the ad template for a secondary color; and insert a second color into the second placeholder, the secondary color based on the subset of secondary colors. In response to identifying that each placeholder in the ad template contains style data, the visual element can then generate an interactive digital ad based on ad elements defined in the ad template and style data representing target formats of a target ad.

In one implementation, the computer system can implement similar methods and techniques as described herein to generate a set of interactive digital ads based on the ad template. For example, the computer system can generate multiple variations of a similar ad based on slight differences in typefaces, colors, and/or other style data defined in the set of style element placeholders in the ad template. Then, the computer system can serve these interactive digital ads to an operator for confirmation, such as by rendering a preview of each interactive digital ad in the target ad slot on the target webpage, so that the operator may determine a similarity between the style elements represented in the interactive digital ad and style elements represented on the webpage. In response to receiving operator confirmation, the computer system can then serve the selected interactive digital ad to the visual element, which renders the selected interactive digital ad in the ad slot on the target webpage.

Accordingly, in response to inserting the relevant data in the particular slot for the ad template, the computer system can generate and serve a candidate ad based on these style elements and the ad template.

### 4. Pre-generated Ads

In one implementation, a computer system can: generate a set of candidate ads; serve the set of candidate ads to an operator; and, in response to receiving confirmation for a particular ad in the set of candidate ads, populate an ad database with the particular ad for later service to a target webpage. In one example, as described in U.S. patent application Ser. No. 18/376,812, filed on 4 Oct. 2023—which is incorporated in its entirety by this reference—the computer system can: autonomously generate a set of responsive, interactive digital ads; serve these ads to an operator for confirmation; iteratively generate ads based on operator feedback; and selectively serve interactive digital ads, confirmed by the operator, to users.

In particular, in the foregoing implementation, the computer system can: access a publisher brand guide defining a set of style rules; access an ad template (or ad description) representing a target ad of a target ad format; identify a target cohort for the target ad, the target cohort exhibiting a set of target concepts; generate a set of candidate ads, of the target ad format, based on the set of style rules, the ad template, and the set of target concepts; serve the set of candidate ads to an operator; and, in response to receiving operator confirmation for a first ad in the set of candidate ads, populating an ad database with the first ad. Then, in response to identifying a particular ad slot on a webpage associated with the set of target concepts, the computer system can select the first ad from the ad database and render the first ad in the particular ad slot on the webpage.

### 4.1 Aggregate Content

In this implementation, the computer system can aggregate content and/or style rules from difference sources. In one example, the computer system can access: a set of publisher style rules, such as from a publisher brand guide; a set of client style rules, such as from a client brand guide; and ad elements in the ad template, such as a set of images, target concepts, target ad format(s).

### 4.1.1 Brand Guidelines

In particular, in this implementation, the computer system can access brand guides, such as publisher and/or client brand guides, each defining a set of style rules and/or blacklisted concepts. For example, the set of style rules can: include a particular color (or set of colors); exclude a particular font; exclude a particular set of themes and/or concepts (e.g., politics); and/or include a second set of themes and/or concepts (e.g., sports, action, adventure.

In one example the computer system can: access a publisher brand guide defining a first set of style (and/or content) rules; access a client brand guide defining a second set of style (and/or content) rules; and identify the union between the first set of style rules and the second set of style rules as the set of style rules for generating ad elements.

In particular, the computer system: accesses a publisher brand guide; extracts a set of style rules based on language signals in the publisher brand guide; accesses a client brand guide; extracts a second set of style rules based on language signals in the client brand guide; identifies union of the first set of style rules and the second set of style rules; excludes an instance of a duplicate rule; generates a target brand guide, defining a set of guidelines for generating ad elements, with the first set of style rules and the second set of style rules.

Accordingly, the computer system can: exclude blacklisted concepts identified in publisher and/or client guidelines; and follow style rules identified in both the client and the publisher guidelines to generate ads with increased likelihood of ad confirmation by both the client and the publisher and decreased turn-around time for ad publishing on a particular publisher site.

### 4.1.2 Target Cohorts

In one implementation, the computer system can: identify a cohort of target viewers exhibiting similar interests (e.g., target concepts); identify a webpage (or a set of webpages) likely to be visited by the set of target viewers; and select the webpage for service of the first interactive digital ad.

In particular, the computer system can: identify a set of interests (e.g., hiking, camping, fishing) for a cohort of target viewers for a particular interactive digital ad, such as based on a client brand guide (e.g., received from an operator) and/or based on contextual elements (e.g., nature, outdoorsy, wilderness) extracted from the first interactive digital ad; assign a contextual element (e.g., hiking) to a particular webpage (e.g., a webpage on local hiking trails) based on content from the webpage; and, based on a similarity between the set of interests and the contextual elements exceeding a threshold similarity, select the webpage for service of the first interactive digital ad.

In one example, the computer system can: identify a first cohort of target viewers for an interactive digital ad; identify a second cohort of projected viewers for a particular webpage; and, in response to the first cohort and the second cohort exhibiting a correspondence exceeding a threshold correspondence, serve the interactive digital ad on an ad slot within the webpage.

In a similar example, the computer system can: generate variations of a particular ad; and selectively serve variations of the particular ad to cohorts of viewers corresponding to content represented in a particular variation of the particular ad.

For example, the computer system can: access a first set of characteristics of a first population of viewers of the target webpage in Block S162; access a second set of characteristics of a second population of viewers of the target webpage in Block S164; and generate a prompt to generate a first set of candidate ads based on the first set of characteristics of the first population of viewers and a second set of candidate ads based on the second set of characteristics of the second population of viewers in Block S130. Then, the computer system can: in response to receiving selection of the first ad via the operator portal, associate the first ad with the first set of characteristics in Block S165; and, in response to receiving selection of a second ad via the operator portal, associate the second ad with the second set of characteristics in Block S166.

Then, the computer system can coordinate with the media player to, for a first instance of the target webpage on a first computing device: access a third set of characteristics of a viewer associated with the first computing device in Block S164; and, in response to the third set of characteristics approximating the second set of characteristics, queue the second ad for insertion into the media player on the first instance of the target webpage in Block S168.

Accordingly, the computer system can identify a cohort of target viewers for a particular ad, such as identified in the ad template for ad generation, and their associated interests, and match these interests to a particular webpage.

Therefore, the computer system can selectively serve interactive digital ads to viewers with a higher likelihood of engagement with the ad to increase viewership engagement and increase seamless integration of the ad with content in the webpage based on the similarity between contextual elements of the webpage and the ad.

### 4.2 Human-in-the-Loop Validation

Generally, the computer system can generate a set of candidate interactive digital ads, based on an ad template and representing a set of style elements, and present the set of candidate interactive digital ads to an operator (e.g., a stakeholder in the responsive media such as the user the computer system generates a set of responsive social media content for) for feedback on the interactive digital ads.

In one implementation, the computer system can prompt the operator to provide feedback such as by: rendering each interactive digital ad in the set of candidate interactive digital ads to the operator in a preview ad slot, such that the operator may view the candidate interactive digital ad in context of the target webpage and compare style elements in the candidate interactive digital ad to style elements on the webpage and proximal the ad slot; rendering an “accept” button proximal each candidate interactive digital ad; rendering a “reject” button proximal each interactive digital ad; and receiving operator input in the form of interaction with each “accept” and “reject” button. In response to the operator selecting “accept” for a first and second candidate interactive digital ad in the set, the computer system can generate a refined set of interactive digital ads exhibiting a similarity (e.g., including the same objects, colors, typefaces, text, and/or ad format) to the first and second interactive digital ads. The computer system can additionally generate the refined set of interactive digital ads to exhibit a dissimilarity (e.g., including different objects, colors, text, and/or ad format) to rejected interactive digital ads in the set of candidate interactive digital ads.

In a similar implementation, the computer system can prompt the operator to arrange the set of candidate interactive digital ads in a ranked list or otherwise indicate a preference for a candidate interactive digital ad in the set of candidate interactive digital ads.

### 4.3 Ad Serving

In one implementation, the computer system can retrieve or otherwise access an interactive digital ad from an internal or external database (e.g., a server or local file storage, such as a browser client). Later, when a user navigates to a webpage via a web browser or to a mobile application via a native application (hereinafter an “app”) executing on her smartphone, tablet, or other computing device, a web server hosted by the publisher can return content or pointers to content for the webpage (e.g., in Hypertext Markup Language, or “HTML”, or a compiled instance of a code language native to a mobile operating system), including formatting for this content and a publisher tag that points the web browser or app to the publisher's computer system (e.g., a network of external cloud servers). The computer system can then: select a particular interactive digital ad (or ad); and serve the responsive media to the web browser or application. In one implementation, the computer system can return the responsive media directly to the web browser or application.

In the foregoing implementation, the computer system or content delivery network, etc. can return the interactive digital ad in the form of content within an HTML iframe element to the web browser or content within view in the mobile application. The mobile application can then place the iframe element within the ad slot on the webpage within the window of the app.

The visual element can then animate visual content of the interactive digital ad (e.g., seek through frames in the set of frames within the visual element) based on the position of the visual element shown within a window rendered on a display of the user's computing device. For example, a computer system executing Blocks of the method S100 can queue a particular ad for rendering by a media player. Then, the media player can load the second ad into the second media player in response to a first scroll event locating the second media player within a viewing window of a first computing device in Block S170.

In particular, the visual element (e.g., a media player) can: load a first ad (e.g., an interactive ad, a scroll-responsive ad) into the media player in response to a first scroll event locating the media player within a viewing window of a computing device in Block S170; render a first portion of the first ad, within the media player, in response to the first scroll event locating the media player to a first vertical position within the viewing window of the computing device in Block S172; render a second portion of the first ad, within the media player, in response to a second scroll event locating the media player to a second vertical position, above the first vertical position, within the viewing window of the computing device in Block S174; and render a call-to-action, associated with the first ad, within the media player in response to a third scroll event locating the media player to a third vertical position, above the second vertical position, within the viewing window of the computing device in Block S176.

Therefore, by rendering the interactive ad as a sequence of visual states in the ad slot responsive to scroll events input by a user, the computer system can increase ad discoverability while preserving visual conformity to the surrounding webpage styling, thereby maintaining continuity of the webpage viewing experience.

### 4.4 Prompt-Based Ad Generation

The method S100 is described herein as executed by a visual element and/or a remote computer system to generate a set of candidate ads based on an ad template, such as an ad container, defining ad elements and other elements present in a target resulting ad. Additionally or alternatively, the computer system can: aggregate content, such as brand guidelines and ad concepts, into a prompt for a particular ad in Block S130; serve the prompt to a model (e.g., large language model, generative design model, front-end framework) in Block S134; and receive a candidate ad of a target ad format in Block S134.

In particular, in this implementation, the computer system can access a textual prompt to generate candidate ads from a prompt library. For example, the computer system can: access a prompt library including a corpus of pre-generated textual prompts for generation of candidate ads; and select a textual prompt, from the prompt library. Additionally or alternatively, the computer system can generate a textual prompt to generate candidate ads, such as in response to requesting a large language model—or any other artificial intelligence model—to generate candidate ads.

Then, in this implementation, the computer system can generate the prompt including: the textual prompt to generate candidate ads; the set of ad elements; the set of style elements; and the set of style rules.

In this implementation, the computer system can then serve the prompt to the image generation model, such as a large language model or any other artificial intelligence model.

In particular, the computer system can access an ad description including a target ad format and a target ad concept; access a first webpage; access a first style sheet for the first webpage, the first style sheet including a set of style elements; select a subset of style elements from the set of style elements based on the set of style rules; and extract contextual elements of the first webpage.

The computer system can then generate a prompt defining a request for an ad of the target ad format by aggregating: the target ad format; the target ad concept; the subset of style elements; and the contextual elements of the first webpage. The computer system can then: serve the prompt to a model (e.g., a large language model); receive a first set of candidate ads from the model; serve the first set of candidate ads to an operator; and, in response to receiving selection of a first ad, in the first set of candidate ads, populate an ad database with the first ad.

In this variation, the computer system can generate a prompt to generate the set of candidate ads based on a content type of the target webpage. For example, the computer system can: extract a set of language signals from the target webpage in Block S122; derive a content type of the target webpage based on the set of language signals in Block S124; and generate a prompt to generate the set of candidate ads based on the content type of the target webpage in Block S130.

Additionally or alternatively, the computer system can implement methods and techniques as described herein to generate (near) real-time interactive digital ads by: serving the prompt to a model (e.g., a large language model); receiving a set of candidate ads from the model; selecting a first ad from the set of candidate ads based on a similarity between the first ad and the set of style rules; and, in response to receiving selection of a first ad, in the first set of candidate ads, rendering the first ad in an ad slot on the target webpage.

Accordingly, the computer system can: autonomously generate ad prompts for service to an ad generation model to output a set of target ads exhibiting a set of target attributes; and, based on a similarity (or conformity) of these ads to style guidelines, selectively serve ads to ad slots on the target webpage.

### 5. Variation: Style Score

In one variation, a computer system executing Blocks of the method S100 can calculate a style score for each candidate ad in the set of candidate ads, the style score representing conformity to the style guidelines specified by the brand and/or the publisher. Additionally or alternatively, the computer system can calculate a style score for each candidate ad in the set of candidate ads, the style score proportional to visual congruence between the target webpage and the candidate ad. In particular, the computer system can select candidate ads, in the set of candidate ads, for presentation to an operator—or for presentation within the target webpage—responsive to these candidate ads exhibiting a style score exceeding a threshold style score.

For example, the computer system can: for each candidate ad in the set of candidate ads, calculate a style score representing adherence of the candidate ad to the set of style rules for the ad campaign in Block S140; and select a subset of candidate ads from the set of candidate ads in response to the subset of candidate ads exhibiting style scores exceeding a threshold Style Score in Block S142.

In this example, the computer system can then: present the subset of candidate ads to an operator via an operator portal in Block S150; and, in response to selection of a first ad, in the subset of candidate ads, at the operator portal, queue the first ad for insertion into a media player on instances of the target webpage in Block S160.

In another example, the computer system: automatically assembles candidate ads; and calculates a style score for each of these candidate ads prior to presentation to the operator. In this example, the computer system can: access an ad template, associated with an ad campaign, intended for presentation within a target webpage; access a set of style rules associated with the ad campaign; extract a set of style elements associated with the second target webpage; assemble a set of candidate ads, for the ad campaign, based on the set of style rules, the set of ad elements, and the set of style elements in Block S180; calculate a style score representing similarity of the candidate ad to the set of style rules in Block S140; and, in response to the style score exceeding a threshold style score, serve the candidate ad to an operator portal in Block S150. Then, in response to selection of a particular ad, in the set of candidate ads, the computer system can queue the particular ad for insertion into a media player on instances of the target webpage.

In the foregoing example, the computer system can calculate the style score based on detecting successful population of template style slots in the set of template style slots.

Additionally or alternatively, in the foregoing example, the computer system can: extract a set of features (e.g., content features, style features) from the candidate ad; and calculate a style score representing correspondence between the set of features and the set of style rules.

Therefore, the computer system can ensure an automatically generated candidate ad excludes blacklisted concepts, defined by the set of styles rules, prior to presentation of these candidate ads to an operator and/or prior to presentation of these candidate ads on the target webpage.

In a similar example, the computer system: automatically assembles candidate ads in Block S180; and calculates a style score for each of these candidate ads prior to selection of an ad for presentation on the target webpage in Block S140.

In particular, in this example, the computer system can: access an ad template, associated with an ad campaign, intended for presentation within a target webpage; access a set of style rules associated with the ad campaign; extract a set of style elements associated with the target webpage; assemble a set of candidate ads, for the ad campaign, based on the set of style rules, the set of ad elements, and the set of style elements; calculate a style score for each candidate in the set of candidate ads, the style score representing correspondence between the candidate ad and the set of style rules; and select a particular ad for insertion into a media player on instances of the target webpage in response to a first style score, associated with the particular ad, exceeding the threshold style score.

Additionally or alternatively, the computer system can calculate a style score for each candidate ad in the set of candidate ads, the style score representing conformity to a local style of the target webpage, such as conformity to style elements, represented within the target webpage, proximal the target ad slot.

In this example, the computer system can: extract a set of contextual elements associated with the second target webpage; and calculate the style score for each candidate in the second set of candidate ads, the style score representing correspondence between the candidate ad and the set of contextual elements associated with the second target webpage.

Therefore, by calculating style scores for each candidate ad, the computer system can quantify compliance of each candidate ad with a set of predefined style rules and content constraints, and then filter or rank the candidate ads based on the style scores to (i) present a vetted subset of candidate ads exceeding a threshold score to an operator and (ii) automatically select, for insertion into an ad slot, a candidate ad exceeding the threshold score, thereby reducing risk of inclusion of non-compliant or blacklisted content.

### 6. Variation: Same-day Ad Generation

In one variation, the visual element can implement methods and techniques as described herein to generate interactive digital ads based on style elements of a particular webpage identified for service of the interactive digital ad. In this variation, the visual element can autonomously render interactive digital ads in the visual element (e.g., an ad slot) located on the webpage and store a representation of the interactive digital ad in an ad database for retrieval.

In particular, in this variation, the visual element can generate and render interactive digital ads during a predefined time period (e.g., less than 24 hours) responsive to operator confirmation. In one example, the visual element can: receive identification of (new) posted content (e.g., a new webpage) on a particular website; identify contextual elements of the posted content; identify an ad template representing similar contextual elements; implement methods and techniques as described herein to generate a candidate ad specific to the posted content and ad elements from a related ad campaign; and render the ad in an ad slot on the webpage.

Therefore, in this variation, the visual element can generate and render interactive digital ads, such as in (near) real time, wherein these ads incorporate style elements, from the webpage, proximal an ad slot on the webpage, to increase visual engagement by a user.

### 7. Variation: CTV+Video Streaming

In a similar variation, the computer system can generate contextual background images for an interactive digital ad, such as a video ad.

In particular, the computer system can: access an interactive digital ad including a video including a sequence of image frames; derive an ad content type of the video based on the sequence of image frames; access a set of target viewership cohorts based on the ad elements type, each target viewership cohort in the set of target viewership cohorts defining a target contextual elements; access a set of input parameters; generate an image related to the interactive digital ad based on the ad elements type, a subset of target contextual elements, and the set of input parameters; and insert the image into a background image slot associated with the interactive digital ad.

In one example, the computer system can: identify a set of input parameters, such as a location of a user (e.g., proximal a beach) and exclusion of a set of blacklist concepts (e.g., political content); access an ad elements type (e.g., “hiking”, “outdoors”); and access a subset of target contextual elements (e.g., “swimming”, “outdoors”) associated with the set of target viewership cohorts. The computer system can then generate an image (e.g., hiking on a beach) associated with content present in the ad and contextual elements associated with target viewership cohorts; and insert the image into a background image slot associated with the video ad.

The method S100 is described herein as extracting style elements from a webpage, and incorporating these style elements into an ad template to generate ads for the webpage. Additionally or alternatively, the computer system can implement similar methods and techniques to extract style elements from a particular video stream and generate a background image for insertion proximal (e.g., behind) a video ad playing during an ad break of the particular video stream.

For example, the computer system can: access a video ad associated with an ad campaign; access a set of style elements of a target video published on a video platform; and access a set of characteristics of a cohort of viewers associated with the target video.

The computer system can then: generate a prompt to generate a background image, for insertion behind the video ad, based on the set of ad elements, the set of style elements of the target video, and the set of characteristics of the cohort of viewers; and serve the prompt to an image generation model.

The computer system can then: present candidate images to an operator—such as via an operator portal—to enable the operator to select a target background image for insertion into the video ad. For example, the computer system can: receive a set of candidate background images from the image generation model; present the set of candidate background images to an operator via an operator portal; and, in response to selection of a first background image in the set of candidate background images, queue the first background image for insertion behind the video ad during playback of the target video (e.g., during an ad break, during an ad placement opportunity).

In another variation, the computer system can implement methods and techniques as described herein to automatically generate and queue background images into video ads based on style scores for these background images. For example, the computer system can: access a video ad associated with an ad campaign; access a set of style elements of a target video published on the video platform; access a set of characteristics of a cohort of viewers associated with the target video; and assemble a set of candidate background images, for the ad campaign, based on the set of ad elements, the set of style elements of the target video, and the set of characteristics of the cohort of viewers. The computer system can then: access a set of style rules associated with the ad campaign; calculate a style score for each candidate background image in the set of candidate background images, the style score representing correspondence between the candidate background image and the set of style rules; and select a background image for insertion behind the video ad during playback of the target video in response to a first style score, associated with a first background image, exceeding a threshold style score.

Therefore, by generating contextual background images for placement behind a video ad, the computer system can further contextualize a cohesive theme or subject presented in the ad elements and webpage content on which an ad is rendered.

The method S100 is described herein as generating a contextual background image for a particular video ad. Additionally or alternatively, the computer system can implement methods and techniques described herein for any other ad format for an ad, such as a static image ad and/or a scroll responsive ad.

### 7.1 Variation: Video Ad

In one variation, the computer system can generate a video ad for presentation with the particular video stream. In particular, the computer system can implement methods and techniques as described herein to extract typeface and color data from a particular video stream. Additionally, the computer system can extract motion characteristics (e.g., transitions, visual patterns), emotional tones based on color palette and/or audio cues, and other style elements from the video stream. The computer system can then: map these style elements to placeholders (or “slots”) in the ad template; and animate a particular sequence of images according to the ad template and style elements.

In this variation, the computer system can identify an ad slot located during a particular video stream. In response to identification of this ad slot, the computer system can: select a subset of frames from the video stream proximal the ad slot; extract a set of style elements from the subset of frames; populate a video ad template with the set of style elements; and generate a video ad based on the video ad template and the set of style elements. The computer system can then: serve the video ad to an operator; and, in response to receiving confirmation from the operator, render the video ad in the ad slot during the video stream.

Accordingly, in this variation, the computer system can generate video ads based on visual and/or audio cues in a particular video stream occurring proximal the video ad slot during the video stream, such that the video ad transitions seamlessly from content in the video stream to content in the video ad to increase visual engagement from a user during playback of the video ad.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a set of ad elements designated for presentation within a target webpage;
accessing a set of style rules assigned to an ad campaign;
accessing a set of style elements representing visual stylistic characteristics of the target webpage;
generating a prompt to generate a set of candidate ads:
based on the set of ad elements and the set of style elements; and
that satisfy the set of style rules for the ad campaign;
serving the prompt to an image generation model;
receiving the set of candidate ads from the image generation model;
for each candidate ad in the set of candidate ads, calculating a style score representing adherence of the candidate ad to the set of style rules for the ad campaign and proportional to visual congruence between the target webpage and the candidate ad;
selecting a subset of candidate ads, from the set of candidate ads, exhibiting style scores exceeding a threshold style score;
presenting the subset of candidate ads to an operator via an operator portal; and
in response to selection of a first ad, in the subset of candidate ads, at the operator portal, queuing the first ad for presentation within instances of the target webpage.

2. The method of claim 1:
wherein generating the prompt comprises:
accessing a textual prompt to generate candidate ads from a prompt library; and
generating the prompt comprising:
the textual prompt to generate candidate ads;
the set of ad elements;
the set of style elements; and
the set of style rules; and
wherein serving the prompt to the image generation model comprises serving the prompt to the image generation model comprising a large language model.

3. The method of claim 1:
further comprising:
extracting a set of language signals from the target webpage; and
interpreting a content type of the target webpage based on the set of language signals; and
wherein generating the prompt to generate the set of candidate ads comprises generating the prompt to generate the set of candidate ads based on the content type of the target webpage.

4. The method of claim 1, further comprising:
in response to a first scroll event locating a media player within a viewing window of a computing device, loading the first ad into the media player on the target webpage;
in response to the first scroll event locating the media player to a first vertical position within the viewing window of the computing device, rendering a first portion of the first ad, within the media player;
in response to a second scroll event locating the media player to a second vertical position, above the first vertical position, within the viewing window of the computing device, rendering a second portion of the first ad, within the media player; and
in response to a third scroll event locating the media player to a third vertical position, above the second vertical position, within the viewing window of the computing device, rendering a call-to-action, associated with the first ad, within the media player.

5. The method of claim 1, wherein accessing the set of ad elements comprises:
accessing an assembled ad generated for the ad campaign; and
extracting the set of ad elements from the assembled ad generated for the ad campaign.

6. The method of claim 1:
further comprising:
accessing a target ad concept associated with the ad campaign;
extracting a set of contextual elements from a region of the target webpage proximal a location of a media player within the target webpage;
deriving a set of correlations between the set of contextual elements and the target ad concept; and
selecting a subset of contextual elements exhibiting correlations, in the set of correlations, exceeding a threshold correlation; and
wherein generating the prompt to generate the set of candidate ads comprises generating the prompt to generate the set of candidate ads based on the subset of contextual elements.

7. The method of claim 1:
wherein accessing the set of style elements for the target webpage comprises, at a media player embedded within the target webpage and during a first time period prior to publication of the target webpage:
accessing the target webpage; and
extracting the set of style elements from the target webpage at the media player embedded within the target webpage; and
further comprising, during a second time period succeeding publication of the target webpage, loading the first ad into the media player within a first instance of the webpage.

8. The method of claim 1, further comprising:
accessing a second set of ad elements designated for presentation within a second target webpage;
accessing a second set of style rules assigned to a second ad campaign;
accessing a second set of style elements representing visual stylistic characteristics of the second target webpage;
assembling the second set of ad elements and the second set of style elements into a second set of candidate ads, for the second ad campaign, based on the second set of style rules;
presenting the second set of candidate ads to the operator via the operator portal; and
in response to selection of a second ad, in the second set of candidate ads, at the operator portal, queuing the second ad for presentation within instances of the second target webpage.

9. The method of claim 8:
further comprising, for each candidate ad in the second set of candidate ads, calculating a second style score representing adherence of the candidate ad to the second set of style rules; and
wherein presenting the second set of candidate ads to the operator comprises, for each candidate ad in the second set of candidate ads, in response to a second style score calculated for the candidate ad exceeding the threshold style score, serving the candidate ad to the operator via the operator portal.

10. The method of claim 8, further comprising, in response to a first scroll event locating a media player within a viewing window of a first computing device, loading the second ad into the media player embedded within the second target webpage.

11. The method of claim 8:
further comprising extracting a set of contextual elements from the second target webpage, the set of contextual elements representing visual characteristics of the second target webpage proximal a media player embedded within the second target webpage and designated for presentation of the second ad; and
wherein calculating the style score for each candidate in the second set of candidate ads comprises, for each candidate in the second set of candidate ads:
calculating a style score representing correspondence between the candidate ad and the set of contextual elements associated with the second target webpage.

12. The method of claim 1:
further comprising:
accessing a first set of characteristics of a first population of viewers of the target webpage; and
accessing a second set of characteristics of a second population of viewers of the target webpage;
wherein generating the prompt to generate the set of candidate ads comprises generating the prompt to generate:
the set of candidate ads based on the first set of characteristics of the first population of viewers; and
a second set of candidate ads based on the second set of characteristics of the second population of viewers; and
further comprising:
in response to receiving selection of the first ad, from the subset of candidate ads, via the operator portal, associating the first ad with the first set of characteristics;
receiving the second set of candidate ads from the image generation model;
for each candidate ad in the second set of candidate ads, calculating a style score representing adherence of the candidate ad to the set of style rules for the ad campaign;
selecting a second subset of candidate ads, from the second set of candidate ads, exhibiting style scores exceeding the threshold style score;
presenting the second subset of candidate ads via the operator portal;
in response to selection of a second ad, in the second subset of candidate ads, at the operator portal, associating the second ad with the second set of characteristics; and
for a first instance of the target webpage accessed via a first computing device:
accessing a third set of characteristics of a viewer associated with the first computing device; and
in response to the third set of characteristics approximating the second set of characteristics, queuing the second ad for insertion into the first instance of the target webpage.

13. A method comprising:
accessing a set of ad elements designated for presentation within a target webpage;
accessing a set of style elements representing visual stylistic characteristics of the target webpage;
accessing a set of style rules assigned to an ad campaign;
generating a set of candidate ads based on, for each candidate ad in the set of candidate ads:
accessing an ad template defining a set of template style slots;
populating the set of template style slots with the set of style elements; and
assembling the set of ad elements into the ad template to generate the candidate ad;
for each candidate ad in the set of candidate ads:
extracting a set of features from the candidate ad; and
calculating a style score proportional to visual congruence between the target webpage and the candidate ad; and
selecting a first candidate ad for insertion into instances of the target webpage in response to a first style score, associated with the first candidate ad, exceeding a threshold style score.

14. The method of claim 13, further comprising, in response to a first scroll event locating a media player within a viewing window of a computing device, loading the first candidate ad into the media player within a first instance of the webpage.

15. The method of claim 13:
further comprising:
extracting a set of language signals from the target webpage; and
interpreting a content type of the target webpage based on the set of language signals; and
wherein generating the set of candidate ads comprises, for each candidate ad in the set of candidate ads:
generating a second set of ad elements based on the content type of the target webpage;
assembling the set of ad elements and the second set of ad elements into the ad template to generate the candidate ad.

16. The method of claim 13:
wherein extracting the set of style elements from a first instance of the target webpage comprises:
accessing a style sheet associated with the target webpage;
extracting a primary typeface from the style sheet;
extracting a secondary typeface from the style sheet;
extracting a primary color from the style sheet; and
extracting a secondary color from the style sheet; and
wherein generating the set of candidate ads comprises, for each candidate ad in the set of candidate ads:
populating a primary typeface slot in the set of template style slots with the primary typeface;
populating a secondary typeface slot in the set of template style slots with the secondary typeface;
populating a primary color slot in the set of template style slots with the primary color; and
populating a secondary color slot in the set of template style slots with the secondary color; and
wherein calculating the style score comprises, for each candidate ad in the set of candidate ads calculating the style score further based on detecting successful population of template style slots in the set of template style slots.

17. The method of claim 16, further comprising, in response to detecting failure to populate the secondary typeface slot in the set of template style slots with the secondary typeface:
querying a typeface library for typefaces visually corresponding to the secondary typeface;
selecting a third typeface from a set of candidate typefaces returned by the typeface library; and
injecting the third typeface, in replacement of the secondary typeface, into the secondary typeface slot in the set of template style slots.

18. The method of claim 13:
wherein accessing the set of style elements representing visual stylistic characteristics of the target webpage comprises:
accessing an image of the target webpage;
extracting a set of features from the image of the target webpage; and
extracting the set of style elements based on the set of features; and wherein generating the set of candidate ads comprises, for each candidate ad in the set of candidate ads, populating each template style slot, in the set of template style slots, with a style element in the set of style elements.

19. A method comprising:
accessing a video ad associated with an ad campaign;
extracting a set of ad elements from the video ad;
accessing a set of style elements of a target video published on a video platform;
accessing a set of characteristics of a cohort of viewers associated with the target video;
generating a prompt to generate a set of candidate background images, designated for presentation behind the video ad, based on the set of ad elements, the set of style elements, and the set of characteristics of the cohort of viewers associated with the target video;
serving the prompt to an image generation model;
receiving a set of candidate background images from the image generation model;
presenting the set of candidate background images to an operator via an operator portal; and
in response to selection of a first background image in the set of candidate background images, queuing the first background image for presentation behind the video ad during playback of the target video.

20. The method of claim 19, further comprising:
accessing a second video ad;
extracting a second set of ad elements from the second video ad;
accessing a second set of style elements of a second target video published on the video platform;
accessing a second set of characteristics of a second cohort of viewers associated with the second target video;
generating a second set of candidate background images based on the second set of ad elements, the second set of style elements of the second target video, and the second set of characteristics of the second cohort of viewers;
accessing a set of style rules;
calculating a style score for each candidate background image in the second set of candidate background images, the style score representing correspondence between the candidate background image and the set of style rules; and
selecting a second background image for presentation behind the second video ad during playback of the second target video in response to a first style score, associated with the second background image, exceeding a threshold style score.
